(19) United States
(12) Patent Application Publication
(10) Pub. No.: US 2022/0003644 A1
(43) Pub. Date: Jan. 6, 2022

(54) FLUIDIC DEVICE, SYSTEM, AND MIXING METHOD

(71) Applicant: NIKON CORPORATION, Tokyo (JP)

(72) Inventor: Ryo KOBAYASHI, Kawasaki-shi (JP)

(21) Appl. No.: 17/256,542

(22) PCT Filed: Jun. 29, 2018
(86) PCT No.: PCT/JP2018/024911

§ 371 Date: Jul. 14, 2021

(51) Int. Cl. G01N 1/38; G01N 35/08

(52) U.S. Cl. CPC G01N 1/38; G01N 2001/386; G01N 35/08

(57) ABSTRACT

An object of the present invention is to provide a small fluidic device. The fluidic device includes: a first substrate, a second substrate, and a third substrate which are sequentially stacked in a thickness direction; a first flow path formed by a groove provided on at least one of the first substrate and the second substrate; and a plurality of circulation flow paths having: a first portion which is formed by a groove provided on at least one of the first substrate and the second substrate and which includes a shared portion that shares part of the flow path with the first flow path; a second portion which is formed by a groove provided on at least one of the second substrate and the third substrate; and a third portion which penetrates through the second substrate in the thickness direction and which connects together the first portion and the second portion at each of positions on both end sides.

### TECHNICAL FIELD

The present invention relates to a fluidic device, a system, and a mixing method.

### BACKGROUND

In recent years, attention has been focused on development or the like of micro-total analysis systems (μ-TAS) with the aim of speeding-up, increasing the efficiency, and integration of tests in the field of in-vitro diagnostics, or ultra-miniaturization of testing equipment, and an active research thereon has proceeded worldwide.

μ-TAS are superior to conventional inspection equipment in that measurement and analysis can be performed with a small amount of sample, the μ-TAS are portable, and the μ-TAS are disposable at low cost.

Furthermore, the μ-TAS are receiving attention as a highly useful method when using expensive reagents or when testing a small amount of multiple samples.

A device including a flow path and a pump disposed on the flow path has been reported as a component of a μ-TAS (Non-Patent Document 1). In such a device, a plurality of solutions are injected into the flow path and the pump is operated to mix the plurality of solutions in the flow path.

### RELATED ART DOCUMENTS

### Non-Patent Document

[Non-Patent Document 1] Jong Wook Hong, Vincent Studer, Giao Hang, W French Anderson and Stephen R Quake, Nature Biotechnology 22, 435-439 (2004)

### SUMMARY OF INVENTION

According to a first aspect of the present invention, there is provided a fluidic device which includes: a first substrate, a second substrate, and a third substrate which are sequentially stacked in a thickness direction; a first flow path which is formed by a groove along a first direction parallel to a joining face between the first substrate and the second substrate, by being provided on one of the first substrate and the second substrate, and being covered with the other of the first substrate and the second substrate; and a plurality of annular second flow paths which are provided independently of each other along the first direction, and each have part of the first flow path as a shared portion, wherein the second flow path has: a first portion which is formed by a groove along a second direction intersecting the first direction parallel to the joining face including the shared portion, by being provided on one of the first substrate and the second substrate, and being covered with the other of the first substrate and the second substrate; a second portion which is formed by a groove along the second direction, by being provided on one of the second substrate and the third substrate, and being covered with the other of the second substrate and the third substrate; and a third portion which penetrates through the second substrate in the thickness direction, and connects together the first portion and the second portion at each of positions on both end sides in the second direction.

According to a second aspect of the present invention, there is provided a fluidic device which includes: a first substrate and a second substrate which are stacked; a first flow path formed by a groove provided on at least one of the first substrate and the second substrate; and a plurality of annular second flow paths that are provided independently of each other along a direction in which a fluid flows in the first flow path and that include a shared portion which shares part of the flow path with the first flow path and a non-shared portion which does not share part of the flow path with the first flow path, wherein in the first flow path, the shared portions of the plurality of second flow paths are adjacent to each other and are connected together via a valve.

According to a third aspect of the present invention, there is provided a system which includes the fluidic device according to the first aspect or the second aspect of the present invention; and a supply unit which is able to supply a force for deforming a valve which is configured to adjust a flow of fluid in the flow path independently for each valve when set in the fluidic device.

According to a fourth aspect of the present invention, there is provided a system which includes: the fluidic device according to the first aspect of the present invention; and a second supply unit which is able to supply a force for collectively deforming the drive valves disposed on a straight line over the plurality of second flow paths via a supply path disposed along the straight line.

According to a fifth aspect of the present invention, there is provided a mixing method which includes preparing a fluidic device which has a first substrate and a second substrate sequentially stacked in a thickness direction, and which includes a first flow path formed by a groove provided on at least one of the first substrate and the second substrate and a plurality of annular second flow paths provided independently of each other along a direction in which a fluid flows in the first flow path, wherein each of the second flow paths is formed by a groove provided on at least one of the first substrate and the second substrate and has a shared portion which shares part of the flow path with the first flow path and a non-shared portion which does not share part of the flow path with the first flow path; introducing a first solution into the first flow path; introducing a second solution into each of the non-shared portions of the plurality of second flow paths; switching the shared portion from part of the first flow path to part of the second flow path; and mixing the first solution and the second solution in the second flow path.

### BRIEF DESCRIPTION OF THE DRAWINGS

FIG. 1 is an external perspective view schematically showing a fluidic device of an embodiment.

FIG. 2 is a plan view schematically showing the fluidic device of the embodiment.

FIG. 3 is a cross-sectional view taken along a line A-A in FIG. 2

FIG. 4 is a cross-sectional view taken along a line B-B in FIG. 2.

FIG. 5 is an enlarged partial plan view of a second flow path 120A.

FIG. 6 is a cross-sectional view taken along a line C-C of a base material 5 in

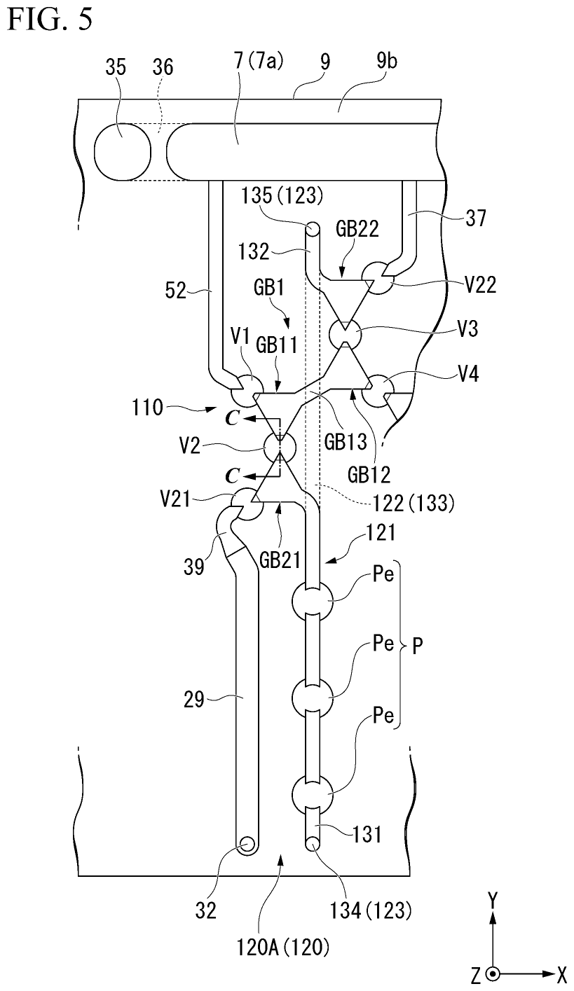

FIG. 5.

FIG. 7 is a partial plan view schematically showing the fluidic device of the embodiment.

FIG. 8 is an external perspective view schematically showing the fluidic device of the embodiment.

FIG. 9 is a cross-sectional view showing a basic configuration of a system SYS of the embodiment.

FIG. 10 is a plan view showing a drive unit TR of the system SYS of the embodiment.

FIG. 11 is a partial plan view showing a modified example of a first flow path 110 and second flow paths 120A to 120E.

### DESCRIPTION OF EMBODIMENTS

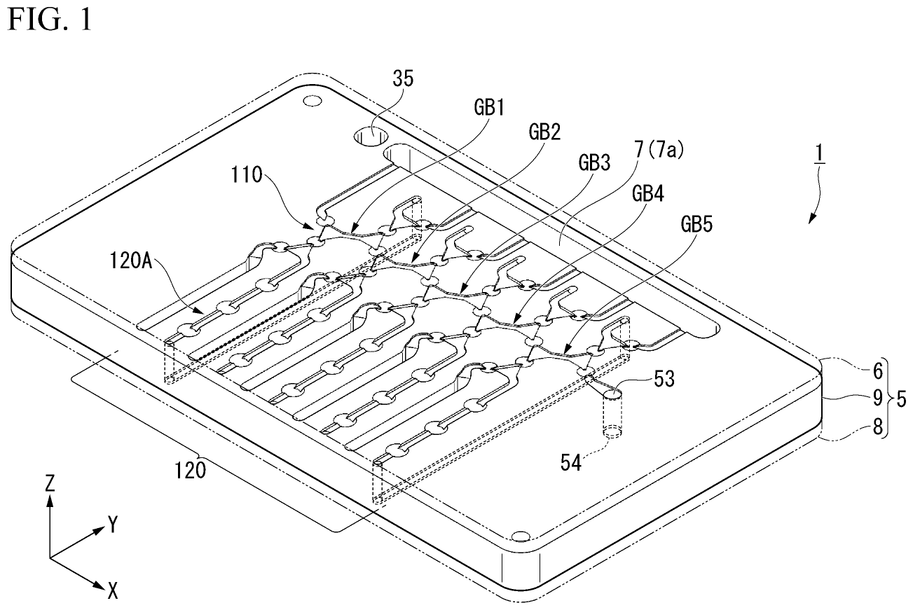

Hereinafter, embodiments of a fluidic device and a system of the present invention will be described with reference to FIGS. 1 to 11. In addition, in the drawings used in the following description, in order to make the features easy to understand, in some cases, the featured parts may be enlarged for convenience, and dimensional ratios or the like between respective components may not be the same as the actual ones.

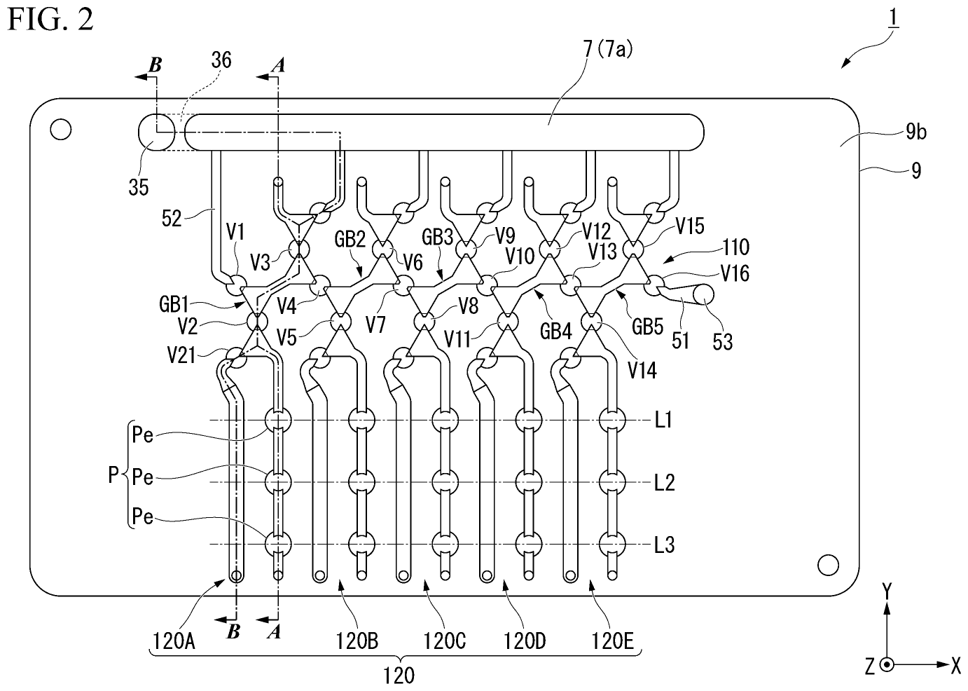

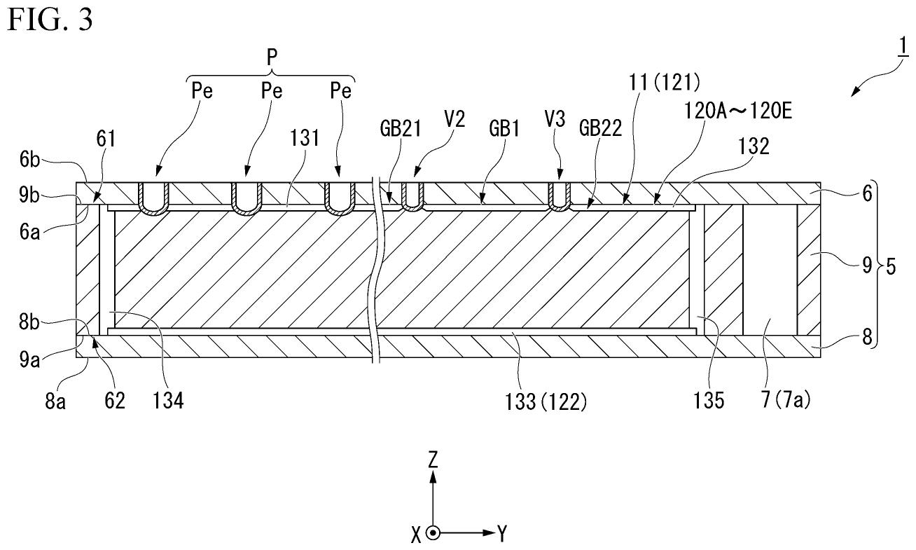

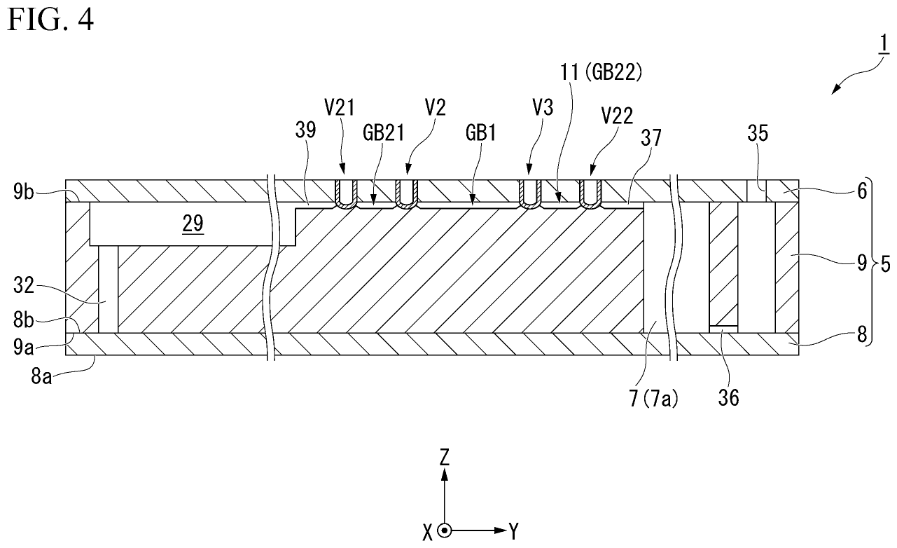

FIG. 1 is an external perspective view schematically showing a fluidic device of an embodiment. FIG. 2 is a plan view schematically showing an example of a flow path provided in the fluidic device 1. In addition, in FIG. 2, a transparent upper plate 6 is shown in a state in which each portion disposed on a side below is transparent. FIG. 3 is a cross-sectional view taken along a line A-A of FIG. 2. FIG. 4 is a cross-sectional view taken along a line B-B of FIG. 2.

The fluidic device 1 of the present embodiment includes a device that detects a sample substance to be detected stored in a specimen sample by an immune reaction, an enzymatic reaction, or the like. The sample substance is, for example, biomolecules such as nucleic acid, DNA, RNA, peptides, proteins, or extracellular endoplasmic reticulum.

As shown in FIG. 1, the fluidic device 1 includes a base material 5. The base material 5 has three substrates (a first substrate 6, a second substrate 9, and a third substrate 8) stacked in a thickness direction. The first substrate 6, the second substrate 9, and the third substrate 8 of the present embodiment are made of a resin material. Examples of the resin material constituting the first substrate 6, the second substrate 9, and the third substrate 8 include polypropylene, polycarbonate and the like. Further, in the present embodiment, the first base material 6 and the third base material 8 are made of a transparent material. The materials constituting the first base material 6, the third base material 8, and the second base material 9 are not limited.

In the following description, it is assumed that the first substrate 6, the second substrate 9, and the third substrate 8 are disposed along a horizontal plane, in the shape of a substantially rectangular plate in a S plane view, the first substrate 6 is located above the second substrate 9, and the third substrate 8 is disposed below the second substrate 9. However, this only defines a horizontal direction and a vertical direction for convenience of explanation, and does not limit the orientation when the fluidic device 1 according to the present embodiment is used.

Further, in the following description, an appropriate explanation will be provided on the assumption that a long side direction of the first substrate 6, the second substrate 9, and the third substrate 8 is an X direction (a first direction), a short side direction (a second direction S) is a Y direction, and the laminating direction orthogonal to the X direction and the Y direction is a Z direction.

The first base material 6 has an upper face 6b and a lower face 6a. The second base material 9 has an upper face 9b and a lower face 9a. Similarly, the third base material 8 has an upper face 8b and a lower face 8a.

The lower face 6a of the first base material 6 faces and is in contact with the upper face 9b of the second base material 9 in the laminating direction. The lower face 6a of the first base material 6 and the upper face 9b of the second base material 9 are joined to each other by a joining means such as adhesion. The lower face 6a of the first base material 6 and the upper face 9b of the second base material 9 form a first boundary face (a joining face) 61. That is, the first base material 6 and the second base material 9 are joined at the first boundary face 61.

Similarly, the upper face 8b of the third base material 8 faces and is in contact with the lower face 9a of the second base material 9 in the laminating direction. The upper face 8b of the third base material 8 and the lower face 9a of the second base material 9 are joined to each other by a joining means such as adhesion. The upper face 8b of the third base material 8 and the lower face 9a of the second base material 9 form a second boundary face (a joining face) 62. That is, the second base material 9 and the third base material 8 are joined at the second boundary face 62.

As shown in FIGS. 3 and 4, the base material 5 is provided with a flow path 11, a reservoir 29, an injection hole 32, a waste liquid tank 7, a discharge path 37, an air hole 35, a supply path 39, valves V1 to V16, and V21 to V22, and a pump P.

The waste liquid tank 7 is provided on the base material 5 for disposal of the solution in the flow path 11. The waste liquid tank 7 is formed in a space by an inner wall face of a penetration hole 7a penetrating the second substrate 9, the lower face 6a of the first substrate 6, and the upper face 8b of the third substrate 8. As shown in FIGS. 1 and 2, the waste liquid tank 7 is formed to extend in the X direction. The waste liquid tank 7 is located near the end edge of the +Y side of the second substrate 9.

As shown in FIGS. 3 and 4, the air hole 35 is provided to penetrate the first substrate 6 and the second substrate 9. As shown in FIGS. 1 and 2, the air hole 35 is disposed on a −X side of the waste liquid tank 7 with an interval therebetween. A groove 36 through which the waste liquid tank 7 and the air hole 35 communicate with each other is formed on the lower face 9a of the second substrate 9.

As shown in FIGS. 1 and 2, the flow path 11 has a first flow path 110 formed of a groove along the X direction, and a plurality (five in FIG. 2) of second flow paths 120A to 120E (appropriately collectively referred to as a second flow path 120) provided independently of each other along the X direction. The fact that the groove is along the X direction means that a straight line connecting both ends in the length of the groove is substantially parallel to the X direction.

The first flow path 110 is provided on the upper face 9b of the second substrate 9 and is formed by being covered with the first substrate 6. The first flow path 110 has a plurality of quantification parts GB1 to GB5 disposed in the X direction to correspond to the plurality of second flow paths 120A to 120E, an introduction path 51, and a discharge path 52.

In the present embodiment, the quantification parts GB1 to GB5 each have the same shape, size, and volume. By making the shapes and sizes of the quantification parts GB1 to GB5 the same (common), it is possible to standardize the arrangement of valves in the plurality of second flow paths 120A to 120E. The shapes, sizes, and volumes of the quantification parts GB1 to GB5 may not be the same. For example, when the quantification parts GB1 to GB5 have the same shape and size but different depths, the volumes of the respective quantification parts GB1 to GB5 can be easily changed without changing the arrangement of the valves. When this configuration is adopted, it is useful for, for example a case of evaluating samples having different concentrations in a plurality of second flow paths 120A to 120E.

Hereinafter, the quantification part GB1 will be described as an example.

FIG. 5 is an enlarged partial plan view of the second flow path 120A. The quantification part GB1 includes merging/branching portions GB11 and GB12 of substantially equilateral triangles, and a connecting part GB13 for connecting them. FIG. 7 is a plan view of the laminating direction view showing the details of the quantification part GB1. As shown in FIG. 7, the merging/branching portions GB11 and GB12 are spaces having an upper face and a lower face of a substantially equilateral triangle. Here, a substantially equilateral triangle means that the longest three sides each form 60 degrees. The merging/branching portions GB11 and GB12 are surrounded by a contour which is parallel to line segments connecting the apex positions (hereinafter, simply referred to as apex positions) of standard equilateral triangles in a plan view (as viewed in the laminating direction (as viewed in the thickness direction view of the second substrate 9)) and offset by a predetermined distance inside the equilateral triangle, and are formed by a recess that is provided on the upper face 9b of the second substrate 9.

The merging/branching portions GB11 and GB12 in the present embodiment have a upper face and bottom face of an equilateral triangular parallel to the upper face 9b of the second substrate 9, and side faces orthogonal to the upper face and the bottom face. Therefore, the contour of the merging/branching portions GB11 and GB12 as viewed in the plan view is formed by a ridge line at which the upper face 9b and the side face of the second substrate 9 intersect.

The upper and bottom faces forming the merging/branching portions GB11 and GB12 are equilateral triangles of the same size and completely overlap in the laminating direction. At least two apex positions of the equilateral triangle are provided with valves that adjust the flow of fluid in the flow path 11 (details thereof will be provided below).

The upper face and the bottom face forming the merging/branching portions GB11 and GB12 are equilateral triangles whose upper face is larger than the bottom face, and may be configured so that the small equilateral triangle which is the bottom face is disposed inside the large equilateral triangle which is the upper face in the laminating direction. At this time, the side faces of the merging/branching portions GB11 and GB12 are inclined inward from the upper face toward the bottom face.

Therefore, the position at which the contours of the merging/branching portions GB11 and GB12 intersect each other (hereinafter, simply referred to as an intersection position) is disposed inside the equilateral triangle. An offset amount between the line segment and the contour is, for example, about 0.1 mm to 0.2 mm. Because a ground plane of the elastomer of the diaphragm member of the valve can be widened by the offset, the valve can be sealed more stably, and further, the volume of the branching portion can be finely adjusted due to the offset. For example, even if the plurality of merging/branching portions have a common valve size, branching portions having different volumes can be obtained by changing the offset amount. Further, the offset amount may be such that the distance on at least one of the three sides is different from the distance on the other side. When this configuration is adopted, the liquid contact area of the valve can be different, and the internal pressure resistance of the valve having a small liquid contact area can be improved.

One of the apex positions at the merging/branching portion GB11 and one of the apex positions at the merging/branching portion GB12 are disposed at the same position.

Further, a gap of a certain distance may be provided between one of the apex positions at the merging/branching portion GB11 and one of the apex positions at the merging/branching portion GB12.

In other words, in the first flow path 110, a pair of merging/branching portions having an equilateral triangle contour as viewed in a plan view are arranged point-symmetrically with a center point as the center, and a plurality of drum-shaped (ribbon-shaped, hourglass-shaped) quantification parts GB1 to GB5 in which the connecting parts passing through the center point connect a pair of merging/branching portions are combined. A plurality of quantification parts GB1 to GB5 as shared portions are arranged consecutively. Adjacent quantification parts GB1 to GB5 share the apex positions of the merging/branching portions. A valve is provided at the apex position shared by adjacent quantification parts GB1 to GB5.

When one of the apex positions in the merging/branching portion GB11 and one of the apex positions in the merging/branching portion GB12 are disposed at the same position, the connecting part GB13 connects together the merging/branching portions GB11 and GB12 via the apex positions disposed at the same position in the merging/branching portion GB11 and GB12. When a gap of a certain distance is provided between one of the apex positions at the merging/branching portion GB11 and one of the apex positions at the merging/branching portion GB12, the connecting part GB13 connects together one of the apex position at the merging/branching portion GB11 and one of the apex positions in the merging/branching portion GB12, and connects the merging/branching portions GB11 and GB12 to each other. The connecting part GB13 is formed by a linear groove as an example. The merging/branching portions GB11 and GB12 and the connecting part GB13 are formed at the same depth. The area and depth (that is, volume) of the merging/branching portions GB11 and GB12 and the connecting part GB13 are set depending on the volume of the solution to be quantified in the quantification part GB1.

Valves V1 and V2 are placed at the (non-disposed) apex positions at which the connecting part GB13 is not disposed in the merging/branching portion GB11. The merging/branching portion GB11 is connected to the discharge path 52 via the valve V1, and can be connected to or shielded from the discharge path 52 depending on the opening and closing of the valve V1. The discharge path 52 is connected to the quantification part GB1 at one end via the valve V1, and is connected to the waste liquid tank 7 at the other end.

Valves V3 and V4 are disposed at the (non-disposed) apex positions at which the connecting part GB13 is not disposed in the merging/branching portion GB12. As shown in FIG. 2, the merging/branching portion GB12 is connected to the quantification part GB2 via the valve V4, and can be connected to or shielded from the quantification part GB2 depending on the opening and closing of the valve V4.

Similarly, the quantification part GB2 is connected to the quantification part GB3 via the valve V7, and can be connected to or shielded from the quantification part GB3 depending on the opening and closing of the valve V7. The quantification part GB3 is connected to the quantification part GB4 via the valve V10, and can be connected to or shielded from the quantification part GB4 depending on the opening and closing of the valve V10. The quantification part GB4 is connected to the quantification part GB5 via the valve V13, and can be connected to or shielded from the quantification part GB5 depending on the opening and closing of the valve V13. The quantification part GB5 is connected to the introduction path 51 via the valve V16, and can be connected to or shielded from the introduction path 51 depending on the opening and closing of the valve V16.

The introduction path 51 is connected to the quantification part GB5 at one end via a valve V16, and is connected to the injection hole 53 at the other end. The injection hole 53 is formed to penetrate the second substrate 9 in the thickness direction. The third substrate 8, as shown in FIG. 1, has an air hole 54 at a position facing the injection hole 53. The air hole 54 is formed to penetrate the third substrate 8 in the thickness direction. The solution is injected into the injection hole 53 via the air hole 54. The injection hole 53 functions as a reservoir and can store (retain) the injected solution. Examples of the solution to be injected and stored in the injection hole 53 include a solution containing a sample such as a specimen.

The first flow path 110 can communicate with the injection hole 53, the waste liquid tank 7, the groove 36, and the air hole 35, by opening the valves V1, V4, V7, V10, V13, and V16 in the state of the valves V2, V3, V5, V6, V8, V9, V11, V12, V14, and V15 being closed. In the first flow path 110, the quantification parts GB1 to GB5 are partitioned by closing the valves V1 to V16.

Returning to FIG. 5, the second flow path 120A is a circulation flow path formed in an annular shape (a loop shape) along a plane substantially parallel to a YZ plane. The second flow path 120A has a first portion 121 provided on the upper face 9b of the second substrate 9 and formed by a groove along the Y direction by being covered with the first substrate 6, a second portion 122 provided in the lower face 9a of the second substrate 9 and formed by a groove along the Y direction by being covered with the third substrate 8, and a third portion 123 which penetrates the second substrate 9 in the thickness direction to connect the first portion 121 and the second portion 122 at positions on both end sides in the Y direction. The third portion 123 may penetrate the second substrate 9 substantially perpendicularly to, for example, a joining face between the first substrate 6 and the second substrate 9 and a joining face between the second substrate 9 and the third substrate 8.

The first portion 121 has merging/branching portions GB21 and GB22, upper face flow paths 131 and 132, and a quantification part GB1. The quantification part GB1 is provided as a shared portion between the first flow path 110 and the second flow path 120A. That is, the quantification part GB1 which is a shared portion is a part of the second flow path 120A which is a circulation flow path.

Like the merging/branching portions GB11 and GB12, the merging/branching portion GB21 is formed by a recess surrounded by a contour that matches the line segment connecting the apex positions of the equilateral triangles in a plan view, or a contour that is parallel to the line segment and offset inside the equilateral triangle by a predetermined distance. One of the apex positions in the merging/branching portion GB21 and one of the apex positions in the merging/branching portion GB11 are disposed at the same position. The merging/branching portion GB21 and the merging/branching portion GB11 can be connected or shielded depending on the opening and closing of the valve V2 disposed at the apex position at the same position.

The upper face flow path 131 is connected to one of the apex positions different from the apex position at which the valve V2 is disposed in the merging/branching portion GB21, and the valve V21 is disposed at the other apex position.

The upper face flow path 131 extends along the Y direction. The upper face flow path 131 is connected to the merging/branching portion GB21 on the +Y side, and a pump P is provided in the middle thereof. The pump P is made up of three element pumps (drive valves) which are disposed side by side in the flow path. The element pump Pe is a so-called valve pump. The pump P can adjust and convey the flow of the solution in the circulation flow path (second flow path 120A), by sequentially opening and closing the three element pumps Pe in cooperation with each other. The number of element pumps Pe constituting the pump P may be three or more, and may be, for example, 4, 5, 6, 7, 8, 9, or 10.

As shown in FIG. 2, each of the element pumps Pe is disposed on straight lines L1 to L3 having the same position in the Y direction and extending in the X direction over the second flow paths 120A to 120E. Therefore, it is possible to drive the element pumps Pe of the second flow paths 120A to 120E in a lump, by supplying the force for driving the element pumps Pe along the straight lines L1 to L3. Therefore, the flow of the solution in the second flow paths 120A to 120E can be synchronized.

Like the merging/branching portion GB21, the merging/branching portion GB22 is formed by a recess surrounded by a contour that matches the line segment connecting the apex positions of the equilateral triangles in a plan view, or a contour parallel to the line segment and offset by a predetermined distance inside the equilateral triangle. One of the apex positions at the merging/branching portion GB22 and one of the apex positions at the merging/branching portion GB12 are disposed at the same position. The merging/branching portion GB22 and the merging/branching portion GB12 can be connected or shielded depending on the opening and closing of the valve V3 disposed at the apex position at the same position.

The upper face flow path 132 is connected to one of the apex positions different from the apex position at which the valve V3 is disposed in the merging/branching portion GB22, and the valve V22 is disposed at the other apex position.

The upper face flow path 132 extends along the Y direction. The upper face flow path 132 is connected to the merging/branching portion GB22 on the −Y side.

The second portion 122 has a lower face flow path 133. The lower face flow path 133 extends along the Y direction. A part of the lower face flow path 133 overlaps the upper face flow paths 131 and 132 and the quantification part GB1 in the laminating direction. That is, a part of the first portion 121 and the second portion 122 overlaps in the thickness direction of the second substrate 9.

The third portion 123 has connection holes 134 and 135. As shown in FIG. 3, the connection hole 134 penetrates the second substrate 9. The connection hole 134 connects together the −Y side end portion of the upper face flow path 131 and the −Y side end portion of the lower face flow path 133. The connection hole 135 penetrates the second substrate 9. The connection hole 135 connects together the +Y side end portion of the upper face flow path 131 and the +Y side end portion of the lower face flow path 133.

As shown in FIG. 5, the reservoir 29 is connected to the second flow path 120A via the supply path 39, and the waste liquid tank 7 is connected to the second flow path 120A via the discharge path 37. The reservoir 29 is provided substantially parallel to the upper face flow path 131. As shown in FIG. 4, the reservoir 29 is formed by a groove that opens to the upper face 9b of the second substrate 9. An injection hole 32 that penetrates the second substrate 9 in the thickness direction and opens to the lower face 9a is formed at the −Y side end portion of the reservoir 29. The solution is injected into the reservoir 29 from the lower face 9a side via the injection hole 32, and stored.

The reservoir 29 is individually and independently provided in each of the second flow paths 120A to 120E. The solution to be filled in the reservoir 29 is, for example, a reagent for a sample stored in the injection hole 53. The reagent filled in the reservoirs 29 may be of the same type or of different types.

The supply path 39 can be connected to or shielded from the merging/branching portion GB21 depending on the opening and closing of the valve V21. The discharge path 37 can be connected to or shielded from the merging/branching portion GB22 depending on the opening and closing of the valve V22. The reservoir 29 in the second flow path 120A is partitioned with respect to the second flow path 120A by closing the valve V21.

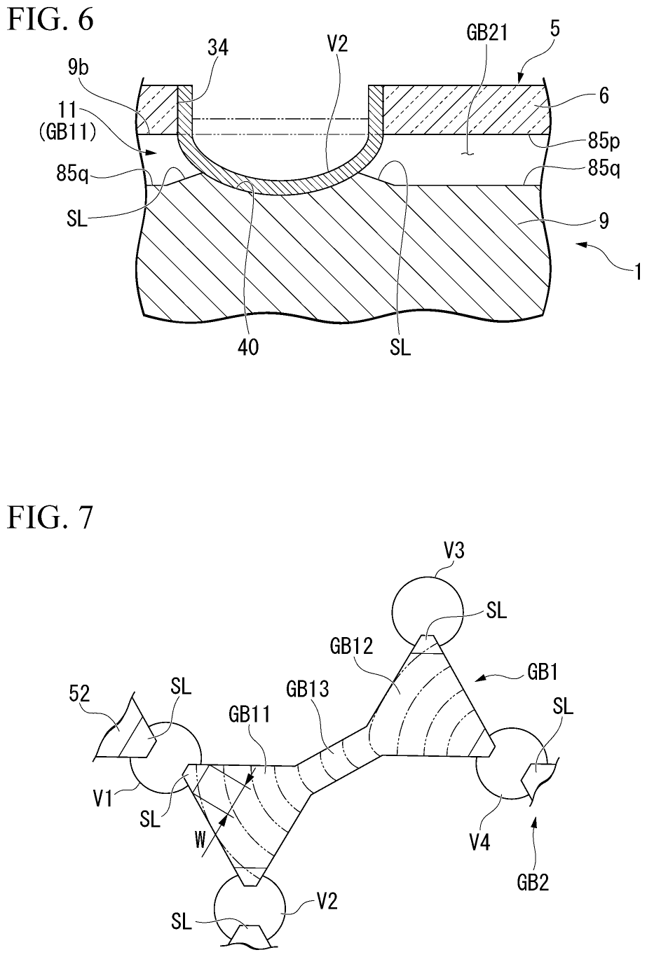

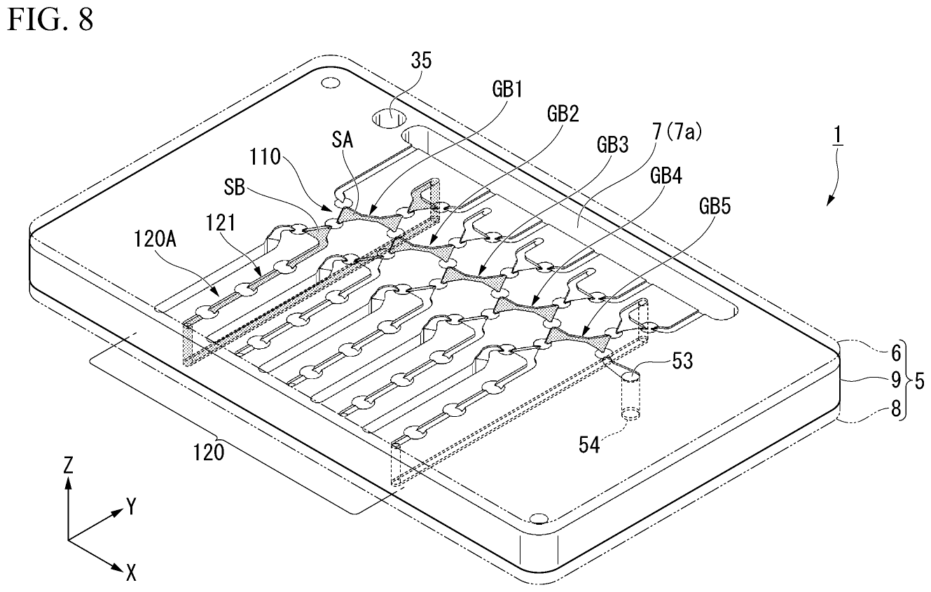

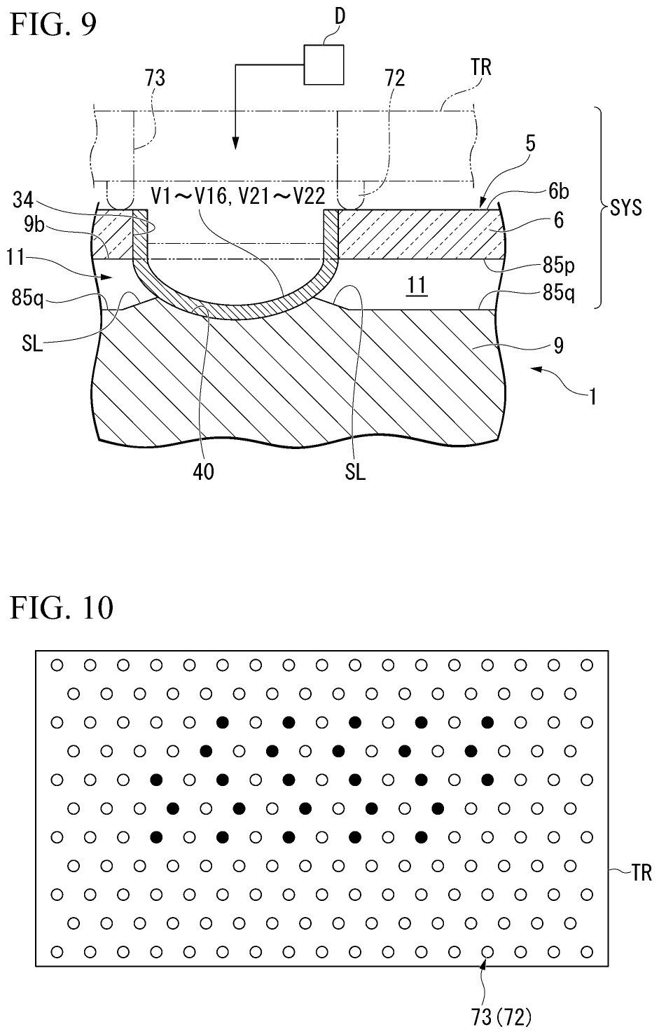

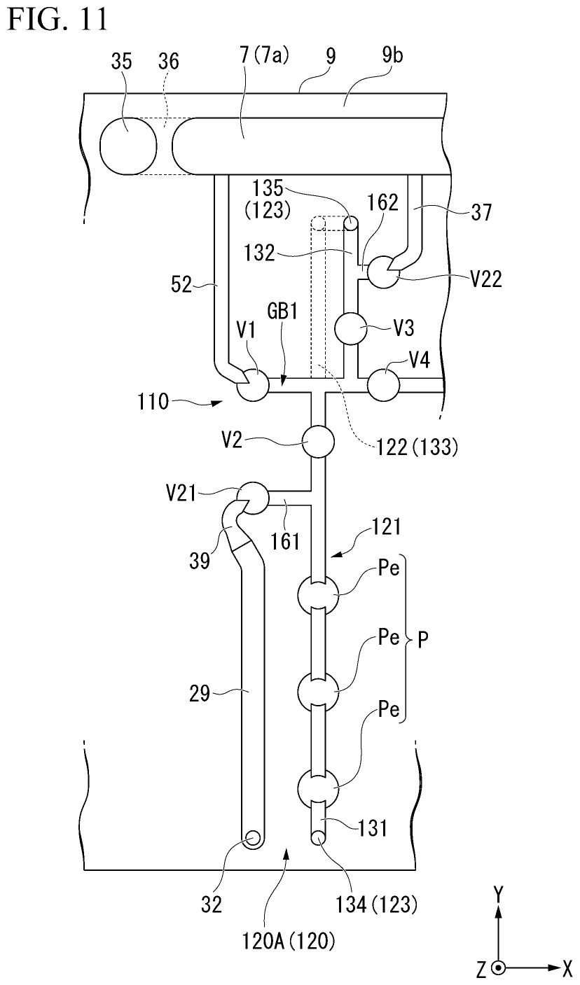

FIG. 6 is a cross-sectional view taken along line C-C of the base material 5 in FIG. 5. Although the structures of the merging/branching portions GB11 and GB21 and the valve V2 will be described here as representatives, the other merging/branching portions and the valves V1 to V16 and V21 to V22 also have the same configuration.

The center positions of the above-mentioned merging/branching portions GB11 to GB12, GB21 to GB22, and valves V1 to V16, and V21 to V22 are each disposed at positions selected from a predetermined number of index points disposed in a two-dimensional hexagonal lattice pattern.

First, a structure of the valve V2 will be described.

As shown in FIG. 6, the first base material 6 is provided with a valve holding hole 34 for holding the valve V2. The valve V2 is held by the first substrate 6 in the valve holding hole 34. The valve V2 is made up of an elastic material. Examples of elastic materials that can be used for the valve V2 include rubber, an elastomer resin or the like. A hemispherical recess 40 is provided in the flow path 11 directly below the valve V2. The recess 40 has a circular shape in a plan view at the upper face 9b of the second material 9. The diameter of the recess 40 on the upper face 9b is preferably, for example, 1.0 to 3.0 mm.

The valve V2 elastically deforms downward to change the cross-sectional area of the flow path, thereby adjusting the flow of the solution in the flow path 11. The valve V2 elastically deforms downward to come into contact with the recess 40, thereby closing the flow path 11. Further, the valve V2 opens the flow path 11 by separating from the recess 40 (a virtual line (two-dot dashed lines) of FIG. 6).

An inclined portion SL which is located at the boundary between the valve V2 (recess 40) and the merging/branching portions GB11 and GB21 and reduces the distance from a top face 85p toward the valve V2 is provided on bottom face 85q of the merging/branching portions GB11 and GB21. By providing the inclined portion SL, for example, as compared with a case at which the inclined portion SL is not provided and there is a step (corner) at the boundary between the bottom portion of the recess 40 and the bottom face 85q of the merging/branching portions GB11 and GB21, the solution can be smoothly introduced into the valve V2, and the residual air bubbles in the step (corner) can be effectively suppressed.

The aforementioned inclined portion SL is also provided at the boundary between each of the discharge path 37 and 52, the supply path 39, the introduction path 51 and the recess 40. The inclined portion SL is particularly effective when the flow path 11 is flat and has lyophilic property with respect to the solution. The flatness of the flow path 11 means that the depth of the flow path 11 is smaller than the width of the flow path 11.

Each inclined portion SL has a tapered shape that reduces in diameter at an angle of 60° toward the center of the valve. A maximum width W (see FIG. 7) of the inclined portion SL in the tapered shape is preferably about 0.5 to 1.5 mm.

When the lowest position of the recess 40 is at a position that is higher than the bottom face 85q of the merging/branching portions GB11 and GB21, the configuration in which the inclined portion SL is provided works effectively. However, when the lowest position of the recess 40 is at a position lower than the bottom face 85q of the merging/branching portions GB11 and GB21, a configuration in which the bottom face 85q and the recess 40 intersect without providing the inclined portion SL may be provided.

(Procedure for Supplying Solution from Injection Hole 53 to the Flow Path 110 for Quantification)

Next, in the fluidic device 1, a procedure for supplying the solution from the injection hole 53 to the first flow path 110 for quantification, and a procedure for supplying the solution from the reservoir 29 to the second flow path 120A for quantification will be described. It does not matter which of the order of the quantification of the solution in the first flow path 110 and the quantification of the solution in the second flow path 120A comes first. Further, the explanation will be provided on the assumption that the injection hole 53 and the reservoir 29 are filled with a predetermined solution in advance.

When supplying a solution to the first flow path 110 for quantification, first, the valves V2, V3, V5, V6, V8, V9, V11, V12, V14, and V15 are closed, and the valves V1, V4, V7, V10, V13, and V16 are opened. As a result, the quantification parts GB1 to GB5, the introduction path 51, and the discharge path 52 constituting the first flow path 110 communicate with the injection hole 53, the waste liquid tank 7, the groove 36, and the air hole 35.

Next, a negative pressure suction is performed in the waste liquid tank 7 from the air holes 35 shown in FIGS. 1 2, 4, and 5 and the like via the groove 36, using a suction device (not shown). Therefore, the solution in the injection hole 53 moves to the flow path 11 side through the introduction path 51. Air that passes through the air hole 54 is introduced to the rear of the solution of the introduction path 51. Therefore, the solution stored in the injection hole 53 is sequentially introduced into the quantification parts GB5 to GB1 and the discharge path 52 via the introduction path 51.

For example, when the valve (third valve) V2 and the valve (fourth valve) V3 are closed, the valve (first valve) V1 and the valve (first valve) V4 are opened, and the solution is introduced into the quantification part GB1, the solution introduced from the quantification part GB2 into the merging/branching portion GB12 via the valve V4 is introduced into the merging/branching portion GB11 via the connecting part GB13.

Here, since the above-mentioned inclined portion SL is provided at the boundary between the quantification part GB2 and the valve V4, the solution can be smoothly introduced into the valve V4 and filled therein, in a state at which residual air bubbles are suppressed at the boundary between the quantification part GB2 and the valve V4 (recess 40). Further, the merging/branching portion GB12 is formed in an equilateral triangle in a plan view, and the distances to the valve V3 and the connecting part GB13 disposed at other apex positions with the valve V4 (recess 40) as a base point are the same. Therefore, the solution introduced from the valve V4 into the merging/branching portion GB12 reaches the valve V3 and the connecting part GB13 almost at the same time as shown by the two-dot chain lines in FIG. 7.

As a result, for example, it is possible to suppress situations in which the solution that has reached the connecting part GB13 first flows into the connecting part GB13 and air bubbles remain in the vicinity of the valve V3.

Further, also for the merging/branching portion GB11 in which the solution is introduced via the connecting part GB13, the merging/branching portion GB11 is formed in an equilateral triangle in a plan view, and distances to the valves V1 and V2 located at another apex position with the connecting part GB13 as a base point are the same. Therefore, the solution introduced from the connecting part GB13 to the merging/branching portion GB11 reaches the valves V1 and V2 almost at the same time as shown by the two-dot chain lines in FIG. 7.

As a result, for example, it is possible to suppress situations in which the solution that has reached the valve V1 first flows into the discharge path 52 and air bubbles remain in the vicinity of the valve V2.

After that, the valves V1, V4, V7, V10, V13, and V16 are closed (that is, the valves V1 to V16 are closed) to partition the quantification parts GB1 to GB5, respectively. As a result, as shown in FIG. 8, the solution SA is quantified in each of the quantification parts GB1 to GB5 in a state in which the residual air bubbles are suppressed.

In other words, the quantification part GB1 is separated from the first flow path 110 in a state at which the solution SA is quantified by closing the valves V1 and V4.

Next, when supplying the solution from the reservoir 29 to the second flow path 120A for quantification, first, the valves V1 to V4 are closed, and the valves V21 and V22 are opened. As a result, the reservoir 29 communicates with the waste liquid tank 7 via the supply path 39, the merging/branching portion GB21 and the upper face flow path 131 forming the first portion 121, the connection hole 134 forming the third portion 123, the lower face flow path 133 forming the second portion 122, the connection hole 135 constituting the third portion 123, the upper face flow path 132 and the merging/branching portion GB22 constituting the first portion 121, and the discharge path 37.

Next, a negative pressure suction is performed inside the waste liquid tank 7 from the air hole 35 via the groove 36, using a suction device described above. As a result, the solution in the reservoir 29 is sequentially introduced into the merging/branching portion GB21, the upper face flow path 131, the connection hole 134, the lower face flow path 133, the connection hole 135, the upper face flow path 132, the merging/branching portion GB22, and the discharge path 37 via the supply path 39.

Even when the solution is introduced into the merging/branching portion GB21 via the supply path 39, the merging/branching portion GB21 is formed in an equilateral triangle in a plan view, and the distances to the valve V2 and the upper face flow path 131 located at other apex positions with the valve V21 as a base point are the same. Therefore, the solution introduced from the supply path 39 into the merging/branching portion GB21 reaches the valve V2 and the upper face flow path 131 almost at the same time, and is introduced into the upper face flow path 131 in a state of suppressing situations in which air bubbles remain.

Similarly, even when the solution is introduced into the merging/branching portion GB22 via the upper face flow path 132, the merging/branching portion GB22 is formed in an equilateral triangle in a plan view, and distances to the valve V3 and the discharge path 37 located at other apex positions with the upper face flow path 132 as a base point are the same. Therefore, the solution introduced into the merging/branching portion GB22 reaches the valve V3 and the discharge path 37 almost at the same time, and is introduced into the discharge path 37 in a state of suppressing situations in which air bubbles remain.

After that, by closing the valves V21 and V22, the region of the second flow path 120A except the quantification part GB1 is partitioned. As a result, as shown in FIG. 8, in the second flow path 120A, the solution SB is quantified in a state at which the residual air bubbles are suppressed in the upper face flow path 131, the connection hole 134, the lower face flow path 133, the connection hole 135, the upper face flow path 132, and the merging/branching portion GB22, except the quantification part GB1.

When quantifying the solution in other second flow paths 120B to 120E, the procedure for quantifying the solution SB in the second flow path 120A except the quantification part GB1 may be performed in the same manner. Further, when quantifying the solution SB in the second flow path 120A, a procedure for quantifying the solution also in one or more of the second flow paths 120B to 120E at the same time may be performed. When the solution is quantified for a plurality of the second flow paths 120A to 120E at the same time, the negative pressure suction force of the suction device increases, but the time required for quantifying the solution can be shortened.

### (Procedure for Mixing Solutions SA and SB in Flow Path 11)

Next, a procedure for mixing the solutions SA and SB supplied to the flow path of the fluidic device 1 will be described. First, as described above, the valves V2 and V3 are opened in a state in which the solution SA is quantified in the quantification part GB1 and the solution SB is quantified in the second flow path 120A except the quantification part GB1. As a result, the quantification part GB1 communicates with a portion of the second flow path 120A other than the shared portion to form an annular second flow path 120A including the quantification part GB1 and along a plane substantially parallel to the YZ plane.

That is, the quantification part GB1 is switched to become a part of the first flow path 110 by opening the valves V1 and V4 and closing the valves V2 and V3 among the valves V1 to V4, and to become a part of the second flow path 120A by opening the valves V2 and V3 and closing the valves V1 and V4.

Further, the solutions SA and SB in the second flow path 120A are sent and circulated, using the pump P. In the solutions SA and SB circulating in the second flow path 120A, the flow velocity around the wall face is slow and the flow velocity at the center of the flow path is high, due to an interaction (friction) between the flow path wall face and the solution in the flow path. As a result, since the flow velocity of the solution can be distributed, the mixing and reaction of the quantified solutions SA and SB are promoted.

As described above, the fluidic device 1 of the present embodiment includes each of the quantification parts GB1 to GB5 constituting a part of the first flow path 110 disposed along the X direction as shared portions, and has the first portion 121 disposed on the upper face 9b along the Y direction, the second portion 122 disposed on the lower face 9a along the Y direction, and the third portion 123 which connects together the first portion 121 and the second portion 122 in the Z direction, and the annular second flow paths 120A to 120E along the plane substantially parallel to the YZ plane are provided independently of each other along the X direction. Accordingly, it is possible to realize miniaturization as compared to a case in which a plurality of annular flow paths are provided independently, for example, in the XY plane. Further, in the fluidic device 1 of the present embodiment, in the first flow path 110, since the quantification parts GB1 to GB5, which correspond to the shared portions with the second flow paths 120A to 120E, are continuous through the valve, the sample can be transferred to the second flow path without waste, as compared to a case in which the sample is transferred to the second flow paths 120A to 120E via a sample introduction flow path branching from the first flow path 110. This is particularly effective when the sample volume is very small.

In particular, in the fluidic device 1 of the present embodiment, since at least a part of the first portion 121 and the second portion 122 overlap in the laminating direction, the fluidic device 1 can be further miniaturized. Therefore, in the fluidic device 1 of the present embodiment, for example, even when one type of sample is tested with a plurality of types of reagents, it is possible to perform the test with a small facility.

Further, in the fluidic device 1 of the present embodiment, since the quantification part GB1 is switched to a part of the first flow path 110 or a part of the second flow path 120A by opening and closing the valves V1 to V4, it is possible to easily and quickly switch the shared portion. That is, the operation of introducing the liquid into the quantification parts GB1 to GB5 in the first flow path 110, and the operation of circulating the liquid in the quantification parts GB1 to GB5 in the second flow paths 120A to 120E can be easily switched. Further, the liquid introduced in the first flow path 110 can be introduced into the second flow paths 120A to 120E without waste.

Further, in the fluidic device 1 of the present embodiment, the first flow path 110 and the second flow paths 120A to 120E are surrounded by contours parallel to the respective line segments connecting the apex positions of the equilateral triangles, and have a pair of merging/branching portions GB11 and GB12 in which merging or branching of solution is performed, it is possible to quantify the solutions SA and SB with high accuracy, while suppressing occurrence of air bubbles. Therefore, in the fluidic device 1 of the present embodiment, it is possible to perform highly accurate measurement, using the solutions SA and SB quantified with high accuracy without being affected by air bubbles.

Further, in the fluidic device 1 of the present embodiment, since each of the element pumps Pe is disposed on straight lines L1 to L3 having the same position in the Y direction and extending in the X direction over the second flow paths 120A to 120E, it is possible to collectively drive each of the element pumps Pe of the second flow paths 120A to 120E. Therefore, in the fluidic device 1 of the present embodiment, the flow of the solution in the second flow paths 120A to 120E can be easily synchronized.

Further, in the fluidic device 1 of the present embodiment, the valves V1 to V16, V21, and V22 including the aforementioned element pump Pe are disposed in the first portion 121 formed on the upper face 9b, force for diving the valves may be supplied from one side (+Z side) of the base material 5 in the laminating direction, which can contribute to miniaturization and cost reduction of the device as compared with a case at which the force is supplied from both sides in the laminating direction.

When the detection unit is provided in the second flow paths 120A to 120E constituting the circulation flow path, it is possible to detect the sample substance contained in the first solution. In addition, when detecting the sample substance, it is possible to directly or indirectly detect the sample substance. As an example of indirectly detecting the sample substance, the sample substance may be combined with a detection auxiliary substance that assists in the detection of the sample substance. When a labeling substance (detection auxiliary substance) is used, a solution containing the sample substance mixed with the labeling substance and combined with the detection auxiliary substance may be used as a first solution. The detection unit may be one that optically detects the sample substance, and as an example, one including an objective lens and an imaging unit be provided. The imaging unit may include, for example, an electron multiplying charge coupled device (EMCCD) camera. Further, the detection unit may be one that electrochemically detects a sample substance, and may include an electrode as an example.

Examples of the labeling substance (detection auxiliary substance) include fluorescent dyes, fluorescent beads, fluorescent proteins, quantum dots, gold nanoparticles, biotin, antibodies, antigens, energy-absorbing substances, radioisotopes, chemical illuminants, enzymes and the like.

Fluorescent dyes include FAM (carboxyfluorescein), JOE (6-carboxy-4′, 5′-dichloro2′, 7′-dimethoxyfluorescein), FITC (fluorescein isothiocyanate), TET (tetrachlorofluorescein), HEX (5′-hexachloro-fluorescein-CE phosphoromidite), Cy3, Cy5, Alexa568, Alexa647 and the like.

Examples of the enzyme include alkaline phosphatase, peroxidase and the like.

Further, when the second flow paths 120A to 120E constituting the circulation flow path are provided with a capture unit capable of capturing the sample substance, the sample substance can be efficiently detected by the detection unit. The sample substance can be concentrated by discharging the solution from the second flow paths 120A to 120E, while continuing to capture the sample substance. Further, the sample substance captured by the capturing portion can be washed, by introducing the cleaning liquid into the second flow paths 120A to 120E and circulating the cleaning liquid, while continuing to capture the sample substance.

By capturing the sample substance itself or the carrier particles bound to the sample substance, the capturing unit can collect the sample substance from the solution circulating in the second flow paths 120A to 120E. The capturing unit is, for example, a magnetic force generating source such as a magnet. The carrier particles are, for example, magnetic beads or magnetic particles.

Further, by providing a circulation flow path different from the second flow paths 120A to 120E as a reaction unit in the fluidic device 1 and providing the detection unit, the capture unit, and the like in the reaction unit, for example, it is possible to perform a desired reaction such as detection, capture, cleaning and dilution.

### [System]

Next, a system SYS including the aforementioned fluidic device 1 will be described with reference to FIGS. 9 and 10.

FIG. 9 is a cross-sectional view showing a basic configuration of the system SYS.

As shown in FIG. 9, the system SYS includes the above-mentioned fluidic device 1 and a drive unit TR. The fluidic device 1 is used by being set in the drive unit TR. The drive unit TR is formed in a plate shape, and when the fluidic device 1 is set, the drive unit TR is disposed to face the upper face 6b of the first base material. The drive unit TR has a contact portion 72 that comes into contact with the upper face 6b of the first base material 6 when the fluidic device 1 is set. The contact portion 72 is formed in an annular shape that surrounds the valve holding hole 34. When the contact portion 72 comes into contact with the upper face 6b of the first base material 6, the contact portion 72 can airtightly seal between the contact portion 72 and the upper face 6b.

The drive unit TR has a drive fluid supply hole (supply unit) 73 that supplies the drive fluid to the valves V1 to V16 and V21 to V22 of the fluidic device 1. A drive fluid (for example, air) is supplied to the drive fluid supply hole 73 from a fluid supply source D. The drive fluid is a force for deforming the valves V1 to V16 and V21 to V22. Further, the drive unit TR has a second supply unit (not shown) that can supply the force for driving the element pumps Pe of the second flow paths 120A to 120E via the supply paths disposed along the straight lines L1 to L3 shown in FIG. 2.

FIG. 10 is a plan view of the drive unit TR. As shown in FIG. 10, the drive unit TR has a plurality of contact portions 72 and drive fluid supply holes 73. The drive fluid can be independently supplied to each drive fluid supply hole 73 from the fluid supply source D. A predetermined number (182 in FIG. 10) of the contact portions 72 and the drive fluid supply holes 73 are arranged in a two-dimensional hexagonal lattice pattern. The center positions of the valves V1 to V16 and V21 to V22 in the fluidic device 1 are disposed at positions (positions shown in black in FIG. 10) selected from the contact portions 72 and the drive fluid supply holes 73 disposed in a two-dimensional hexagonal lattice pattern.

In the system SYS having the aforementioned configuration, when the fluidic device 1 is set in the drive unit TR, and the drive fluid is supplied from the fluid supply source D in response to the opening and closing of the valves V1 to V16 and V21 to V22 described above, it is possible to perform introduction of the solution SA into the first flow paths 110 (quantification parts GB1 to GB5), introduction of the solution SB into the second flow path 120A except the quantification part GB1, and mixing of the solutions SA and SB in the second flow path 120A.

In the system SYS of the present embodiment, by disposing the valves V1 to V16 and V21 to V22 of the fluidic device 1 at a position selected from the contact portions 72 and the drive fluid supply holes 73 disposed in the two-dimensional hexagonal lattice pattern, as mentioned above, it is possible to easily provide the merging/branching portion surrounded by a contour parallel to the line segment connecting the apex positions of the equilateral triangle. Therefore, in the system SYS of the present embodiment, it is possible to design an optimal flow path capable of suppressing the occurrence of air bubbles when the solution is introduced, depending on the measurement (inspection) target, without being limited to the arrangement and number of the flow paths 11 and the merging/branching portions GB11 and GB12 in the fluidic device 1.

Although the preferred embodiments according to the present invention have been described above with reference to the accompanying drawings, it goes without saying that the present invention is not limited to such examples. Various shapes and combinations of each constituent member shown in the above-mentioned examples are examples, and can be variously changed on the basis of design requirements and the like without departing from the gist of the present invention.

For example, the arrangement and number of the flow paths, the merging/branching portions, and the valves shown in the aforementioned embodiment are examples, and as described above, by disposing the valve (and the merging/branching portion, and the flow path) of the fluidic device 1 at the position selected from the contact portions 72 and the drive fluid supply holes 73 disposed in a two-dimensional hexagonal lattice pattern, it is possible to easily cope with various measurement (inspection) targets.

Further, although the configuration in which five second flow paths 120A to 120E having a part of the first flow path 110 as a shared portion are provided is shown as an example, the number of the second flow paths may be two or more.

Further, in the above embodiment, the configuration in which the contours of the merging/branching portions GB11 and GB12 are parallel to the line segment connecting the apex positions of the equilateral triangles in which the center positions of the valves V1 to V16 and V21 to V22 are disposed is shown as example. However, the configuration is not limited thereto, and for example, a configuration in which the contour is a line segment connecting the apex positions may be provided.

Further, in the above embodiment, the configuration in which the first portion 121 of the second flow paths 120A to 120E is provided on the upper face 9b of the second substrate 9, and the second portion 122 is provided on the lower face 9a of the second substrate 9 is shown as an example. However, the embodiment is not limited to this configuration. For example, a configuration in which the first portion 121 is provided on the lower face 6a of the first substrate 6, or a configuration in which the first portion 121 straddles the first boundary face 61 and is provided on both the upper face 9b of the second substrate 9 and the lower face 6a of the first substrate 6 may be provided. Further, a configuration in which the second portion 122 is provided on the upper face 8b of the third substrate 8, or a configuration in which the second portion 122 straddles the second boundary face 62 and is provided on both the lower face 9a of the second substrate 9 and the upper face 8b of the third substrate 8 may be provided. When the groove serving as a flow path is provided on only one substrate, processing and alignment between the substrates are easy.

Further, in the above embodiment, although the configuration in which the first flow path 110 and the second flow paths 120A to 120E have a merging/branching portion surrounded by a contour parallel to each line segment connecting the apex positions of the equilateral triangles has been shown as an example, the embodiment is not limited thereto. FIG. 11 is a partial plan view showing a modified example in which merging or branching of solutions are performed in a linear flow path in the second flow path 120A and the first flow path 110, which are typically shown among the second flow paths 120A to 120E.

As shown in FIG. 11, the first flow path 110 is formed by a linear flow path extending in the X direction, and valves V1 and V4 are disposed at intervals. A quantification part GB1 is formed between the valves V1 and V4. In the quantification part GB1, a +Y side end portion of the linear upper face flow path 131 in which the connection hole 134 and the pump P are disposed is connected with a −Y side end portion of the linear upper face flow path 132 in which the connection hole 135 is formed at the +Y side end portion. The upper face flow path 131 and the upper face flow path 132 constituting the first portion 121 extend in the Y direction and are disposed apart from each other in the X direction.

A valve V2 is disposed in the vicinity of the quantification part GB1 in the upper face flow path 131. An introduction flow path 161 having one end connected to the valve V21 is connected between the pump Pin the upper face flow path 131 and the valve V2. A valve V3 is disposed in the vicinity of the quantification part GB1 in the upper face flow path 132. A discharge path 162 having one end connected to the valve V22 is connected between the connection hole 135 in the upper face flow path 132 and the valve V3.

The lower face flow path 133 constituting the second portion 122 has the same position in the X direction as the upper face flow path 131, and is disposed to overlap in the laminating direction. The connection hole 135 penetrates the second substrate 9 obliquely with respect to the laminating direction (inclined about the Y axis with respect to the Z axis), and connects together the +Y side end portions of the upper face flow path 132 and the lower face flow path 133. The second flow path 120A except the quantification part GB1 is formed in a plane substantially parallel to the YZ plane.

Other second flow paths 120B to 120E have the same configuration as the second flow path 120A.

In the modified example of the fluidic device 1, as described above, in the state in which the valves V2 and V3 are closed, and the valves V1 and V4 are opened, by closing the valves V1 and V4 after the solution SA is introduced into the first flow path 110, a predetermined amount of solution SA is quantified in the quantification part GB1.

Next, in the state in which the valves V1 to V4 are closed and the valves V21 and V22 are opened, by closing the valves V21 and V22 after sequentially introducing the solution SB into the upper face flow path 131, the connection hole 134, the lower face flow path 133, the connection hole 135, and the upper face flow path 132 via the introduction flow path 161, the region of the second flow path 120A except the quantification part GB1 is partitioned to quantify the solution SB.

Further, in the state in which the solution SA is quantified in the quantification part GB1, and the solution SB is quantified in the second flow path 120A except the quantification part GB1, the solutions SA and SB in the second flow path 120A are sent and circulated, using the pump P. As a result, the solutions SA and SB can be mixed by the small fluidic device 1 in which the second flow paths 120A to 120E are formed in a plane substantially parallel to the YZ plane.

### DESCRIPTION OF THE REFERENCE SYMBOLS

1 Fluidic device
6 First substrate
8 Third substrate
9 Second substrate
11 Flow path
61 First boundary face (joining face)
62 Second boundary face (joining face)
73 Drive fluid supply hole (supply unit)
110 First flow path
120, 120A to 120E Second flow path
121 First portion
122 Second portion
123 Third portion
GB1 to GB5 Quantification part (shared portion)
GB11, GB12 Merging/branching portion
GB13 Connecting part
Pe Element pump (drive valve)
TR Drive unit
V1 Valve (first valve)
V2 Valve (third valve)
V3 Valve (fourth valve)
V4 Valve (first valve)

1. A fluidic device comprising:
a first substrate, a second substrate, and a third substrate which are sequentially stacked in a thickness direction;
a first flow path formed by a groove provided on at least one of the first substrate and the second substrate; and
a plurality of circulation flow paths having:
a first portion which is formed by a groove provided on at least one of the first substrate and the second substrate and which includes a shared portion that shares part of the flow path with the first flow path;
a second portion which is formed by a groove provided on at least one of the second substrate and the third substrate; and
a third portion which penetrates through the second substrate in the thickness direction and which connects together the first portion and the second portion at each of positions on both end sides.

2. The fluidic device according to claim 1, comprising:
a switching unit capable of switching the shared portion to part of the first flow path or part of the second flow path.

3. The fluidic device according to claim 2,
wherein the switching unit includes a valve which is configured to adjust a flow of a solution in the flow path.

4. The fluidic device according to claim 3,
wherein the shared portion includes a first valve and a second valve that are provided in the first flow path and a third valve and a fourth valve that are provided in the second flow path.

5. The fluidic device according to claim 1,
wherein the first portion and the second portion are grooves in which a fluid flows along a second direction intersecting a first direction along which a fluid flows in the first flow path.

6. The fluidic device according to claim 1,
wherein at least one of the first flow path and the second flow path has a pair of merging/branching portions each of which is surrounded by a contour which matches each line segment connecting together apex positions of an equilateral triangle in a view of the thickness direction or a contour parallel to each line segment and in which merging or branching of a solution is performed.

7. The fluidic device according to claim 6,
wherein in the pair of merging/branching portions, a valve which is configured to adjust a flow of fluid in the flow path is provided at two or more of the apex positions of the equilateral triangle.

8. The fluidic device according to claim 6,
wherein the merging/branching portion is disposed in the shared portion.

9. The fluidic device according to claim 1,
wherein the first flow path and the second flow path include a valve which is configured to adjust a flow of fluid, and
a center position of the valve is disposed at each of positions selected from a predetermined number of index points disposed in a two-dimensional hexagonal lattice pattern.

10. The fluidic device according to claim 1,
wherein each of the plurality of second flow paths has a predetermined number of drive valves which operate in cooperation with each other and which adjust a flow of fluid in the second flow path, and
each of the predetermined number of drive valves is disposed on a straight line extending in the first direction over the plurality of second flow paths.

11. The fluidic device according to claim 10,
wherein the drive valve is disposed in the first portion.

12. The fluidic device according to claim 1,
wherein the second flow path has a second merging/branching portion which is each surrounded by a contour that matches each line segment connecting together apex positions of an equilateral triangle in a view of the thickness direction or a contour parallel to each line segment and in which merging or branching of a solution is performed, and
the solution is introduced into the second flow path via the second merging/branching portion.

13. The fluidic device according to claim 1,
wherein a reservoir which is configured to store a solution introduced into the second flow path is provided separately and independently in each of the plurality of second flow paths.

14. A fluidic device comprising:
a first substrate and a second substrate which are stacked;
a first flow path formed by a groove provided on at least one of the first substrate and the second substrate; and
a plurality of annular second flow paths that are provided independently of each other along a direction in which a fluid flows in the first flow path and that include a shared portion which shares part of the flow path with the first flow path and a non-shared portion which does not share part of the flow path with the first flow path,
wherein in the first flow path, the shared portions of the plurality of second flow paths are adjacent to each other and are connected together via a valve.

15. A system comprising:
the fluidic device according to claim 1; and
a supply unit which is able to supply a force for deforming a valve which is configured to adjust a flow of fluid in the flow path independently for each valve when set in the fluidic device.

16. The system according to claim 15,
wherein a predetermined number of the supply units are disposed in a two-dimensional hexagonal lattice pattern, and
the valve is disposed at a position selected from the supply units disposed in a predetermined number in the two-dimensional hexagonal lattice pattern.

17. A system comprising:
the fluidic device according to claim 10; and
a second supply unit which is capable of supplying a force for collectively deforming the drive valves disposed on a straight line over the plurality of second flow paths via a supply path disposed along the straight line.

18. A mixing method comprising:
preparing a fluidic device
which has a first substrate and a second substrate which are sequentially stacked in a thickness direction, and
which includes a first flow path formed by a groove provided on at least one of the first substrate and the second substrate and a plurality of annular second flow paths provided independently of each other along a direction in which a fluid flows in the first flow path, wherein
each of the second flow paths is formed by a groove provided on at least one of the first substrate and the second substrate and has a shared portion which shares part of the flow path with the first flow path and a non-shared portion which does not share part of the flow path with the first flow path;
introducing a first solution into the first flow path;
introducing a second solution into each of the non-shared portions of the plurality of second flow paths;
switching the shared portion from part of the first flow path to part of the second flow path; and
mixing the first solution and the second solution in the second flow path.

19. The mixing method according to claim 18,
wherein the shared portion includes a first valve and a second valve that are provided in the first flow path and a third valve and a fourth valve that are provided in the second flow path, and
the mixing method comprises:
introducing a first solution into the first flow path in a state of the third valve and the fourth valve being closed and the first valve and the second valve being open;
after introducing the first solution, closing the first valve and the second valve, and quantitatively partitioning the first solution; and
opening the third valve and the fourth valve and introducing a second solution into the second flow path.
